(19) United States
(12) Patent Application Publication
(10) Pub. No.: US 2024/0183273 A1
(43) Pub. Date: Jun. 6, 2024

(54) ROTOR BALANCING APPARATUS

(71) Applicant: ROLLS-ROYCE plc, London (GB)

(72) Inventor: John M. HARRISON, Bristol (GB)

(73) Assignee: ROLLS-ROYCE plc, London (GB)

(21) Appl. No.: 18/508,497

(22) Filed: Nov. 14, 2023

(30) Foreign Application Priority Data
Dec. 6, 2022 (GB) 2218282.8

(51) Int. Cl. F01D 5/02

(52) U.S. Cl. CPC F01D 5/027; F05D 2220/323; F05D 2260/96

(57) ABSTRACT

Disclosed is a gas turbine engine rotor balancing apparatus comprising: a rotor configured to rotate about a rotor axis; a substantially annular balancing mass configured to encircle the rotor; and a mass adjustment apparatus for adjusting the position of the balancing mass relative to the rotor.

### CROSS-REFERENCE TO RELATED APPLICATIONS

This specification is based upon and claims the benefit of priority from UK Patent Application No. GB 2218282.8, filed on Dec. 6, 2022, the entire contents of which is incorporated herein by reference.

### BACKGROUND

### Technical Field

The present disclosure concerns a rotor balancing apparatus and, more particularly, a rotor balancing apparatus for a rotor of a gas turbine engine.

### Description of the Related Art

In a gas turbine engine, various rotors rotate at high rotational velocity in operation. A rotor and its components can be balanced before installation or if removed from the engine, but these methods are time consuming and can be unsuccessful if the balance state is affected by the installation process. It should be understood that solutions are required for balancing a rotor while it is installed and enclosed in a casing.

### SUMMARY

According to a first aspect of the present disclosure, there is provided a gas turbine engine rotor balancing apparatus comprising: a rotor configured to rotate about a rotor axis; a substantially annular balancing mass configured to encircle the rotor; and a mass adjustment apparatus for adjusting the position of the balancing mass relative to the rotor.

The gas turbine engine rotor balancing apparatus may further comprise a substantially annular engine casing. The rotor, balancing mass, and mass adjustment apparatus may be contained within the engine casing.

The gas turbine engine rotor balancing apparatus may be configured to permit adjustment of the balancing mass while the rotor is in-situ in the engine casing.

The engine casing may comprise an access port formed through a wall of the engine casing, so as to provide access to the balancing mass and the mass adjustment apparatus within the casing. The access port may be a boroscope port.

The access port may be provided at an axial position on the engine casing substantially coincident with an axial position of the balancing mass. A single access port may be provided, or a plurality of circumferentially spaced access ports may be provided.

The mass adjustment apparatus may comprise a moveable spacing element configured to contact the balancing mass and the rotor so as to set a radial spacing between the balancing mass and the rotor. The moveable spacing element may be moveable relative to one or both of the balancing mass and the rotor.

The mass adjustment apparatus may comprise a plurality of movable spacing elements spaced circumferentially about the balancing mass and/or the rotor, so as to set the radial spacing between the balancing mass and the rotor at a plurality of discrete positions about a circumference of the rotor.

The mass adjustment apparatus may comprise three moveable spacing elements spaced equidistantly about the circumference of the balancing mass.

The position of the moveable spacing element may be radially moveable relative to the balancing mass.

The moveable spacing element or elements may be a grub screw provided on the balancing mass. The grub screw may be configured to move substantially radially relative to the balancing mass by rotation of the grub screw. The or each grub screw may be arranged in a substantially radially extending bore in or through the balancing mass. An opening may be provided on the outer radial surface of the balancing mass to provide access to the grub screw.

The moveable spacing element may be arranged in a radially extending bore through the balancing mass. A radially outer opening of the bore may be smaller than the moveable spacing element. The or each bore may comprise a flange which extends into the bore at its radially outer end, such that the radially outer opening of the bore has a diameter less than the diameter of the moveable spacing element or grub screw.

The balancing mass may be configured to rotate with the rotor.

The mass adjustment apparatus may be configured to secure the balancing mass in a fixed position relative to the rotor, such that the balancing mass rotates with the rotor.

The rotor, the balancing mass, and/or the mass adjustment apparatus may comprise one or more keying features configured to secure the balancing mass in a fixed angular position relative to the rotor.

Where the mass adjustment apparatus comprises a spacing element, the rotor and/or the balancing mass may comprise a complementary keying feature, such as a recess or protrusion, configured to engage an end portion of the spacing element and secure the spacing element in a fixed angular position relative to the rotor and the balancing mass.

The rotor may comprise a substantially annular recess. The balancing mass may be configured to be at least partially received in the annular recess. The annular recess may be configured to secure the balancing mass at a fixed axial position relative to the rotor.

The rotor may comprise a first rotor component and a second rotor component arranged axially adjacent to the first rotor component. The balancing mass and/or the annular recess may be arranged at, or proximate to, a joint between the first and second rotor components.

According to a second aspect of the present disclosure, there is provided a gas turbine engine comprising a gas turbine engine rotor balancing apparatus according to the first aspect.

According to a third aspect of the present disclosure, there is provided an aircraft comprising one or more gas turbine engines according to the second aspect.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a detailed sectional side view of a portion A of the gas turbine engine of FIG. 1 on the plane A-A shown in FIG. 3;

FIG. 3 is a schematic sectional axial view of the gas turbine engine core on the plane B-B of FIGS. 1 and 2; and

FIG. 4 is a schematic view of an aircraft comprising a gas turbine engine.

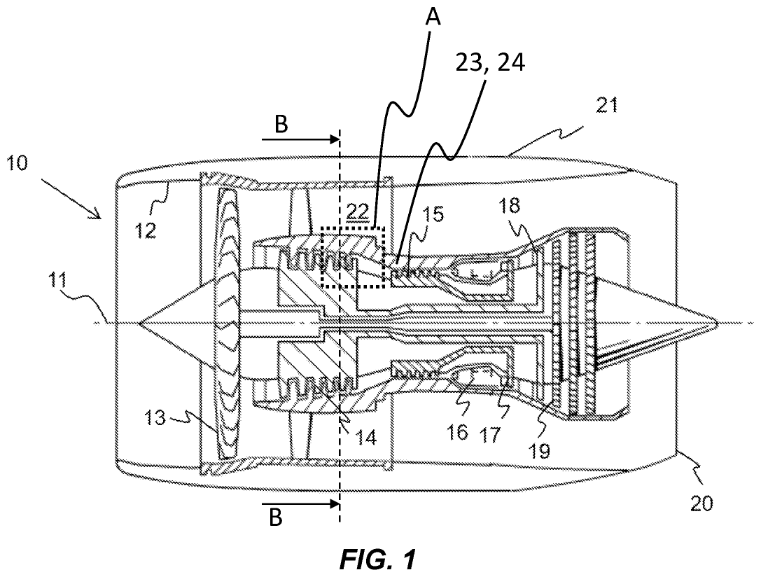

With reference to FIG. 1, a gas turbine engine is generally indicated at 10, having a principal and rotational rotor axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine and defines both the intake 12 and the exhaust nozzle 20. The intermediate pressure compressor 14, the high-pressure compressor 15, combustion equipment 16, the high-pressure turbine 17, the intermediate pressure turbine 18, and the low-pressure turbine 19 are all contained within a tubular engine casing 23, so as to form an engine core 24. The fan 13 is not located within the engine casing 23, but may still be considered to form part of the engine core 24.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g., two) and/or an alternative number of compressors and/or turbines. Further the engine may comprise a gearbox provided in the drive train from a turbine to a compressor and/or fan.

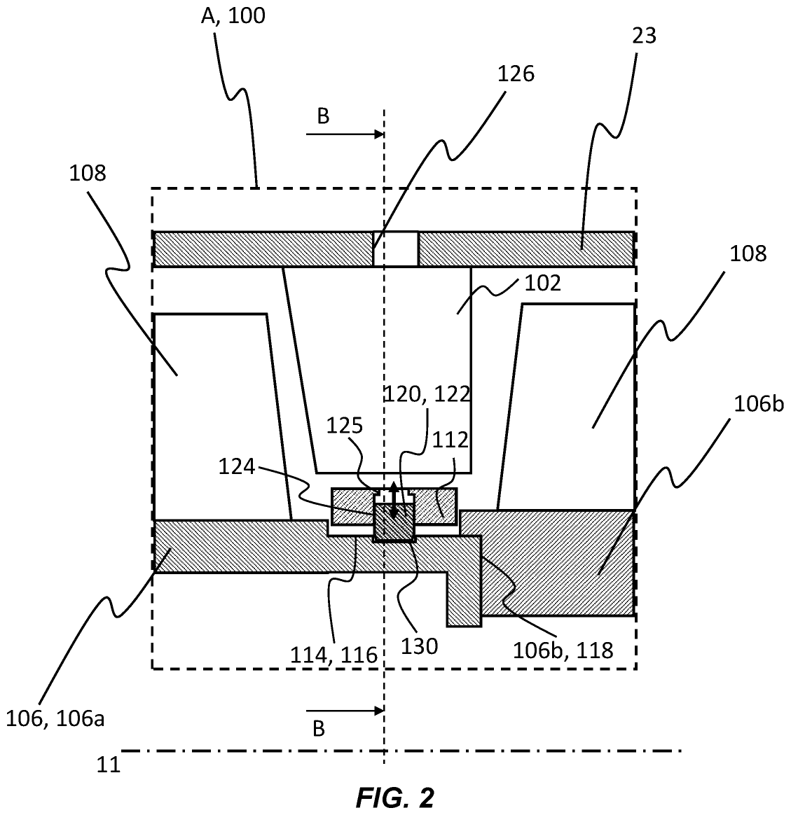

FIG. 2 shows a detailed sectional view of portion A of the gas turbine engine 10, as shown in FIG. 1. In particular, FIG. 2 shows a gas turbine engine rotor balancing apparatus 100.

FIG. 2 shows a portion of the engine casing 24 and the internal structure of a representative portion of one of the compressors 14, 15.

A rotor 106 of the gas turbine engine 10 is also shown in FIG. 2. In this example, the rotor 106 is a turbine rotor, but it should be understood that the principles of the present disclosure may also or alternatively be applied to various other rotors within the engine 10, such as compressor rotors, fan rotors, and interconnecting shafts. More generally, the principles of the disclosure may be applied to any rotating component in the gas turbine engine 10.

The rotor 106 is configured to rotate about the rotor axis 11. The casing 23 is static, and the rotor 106 rotates relative to the casing 23. The rotor 106 and the casing 23 are substantially coaxial about rotor axis 11.

In this example, the rotor 106 comprises a first rotor component 106a and a second rotor component 106b. The first rotor component 106a is arranged axially forward, and adjacent to the second rotor component 106b. A joint 106c is formed between the rotor components 106a,b, such that they are substantially fixedly connected, and rotate together as a single rotor 106.

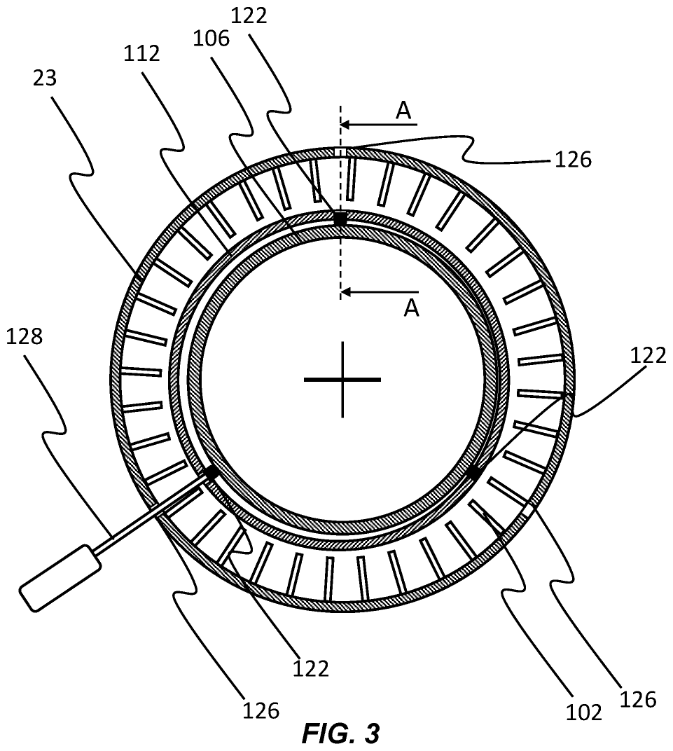

A number of static aerofoils or vanes 102 are secured to the radially inner surface 104 of the engine casing 23. The vanes 102 are circumferentially spaced about the casing 23 as also shown in FIG. 3. A number of corresponding blades 108 are secured to the radially outer surface 110 of the rotor 106. In use, the rotor 106 rotates, which in turn rotates the blades 108, which compresses air travelling through the compressor.

The rotor 106 is a complex component comprising multiple subcomponents, such as the blades 108. It is known for a rotor to be balanced before installation in an engine casing. However, the installation process or general wear and use may cause the rotor to become unbalanced, which may cause excessive vibration or damage.

In order to facilitate balance adjustment while the rotor 106 is in-situ in the engine 10, a gas turbine rotor balancing apparatus 100 is provided.

With reference to FIG. 2 and FIG. 3, the gas turbine engine rotor balancing apparatus 100 comprises a substantially annular balancing mass 112 configured to encircle the rotor 106. The balancing mass 112 takes the form of an annular ring. The balancing mass has an internal diameter and an external diameter, a thickness (in the up/down direction in FIG. 2), and an axial length L (in the left/right direction in FIG. 2). The internal diameter is larger than the external diameter of the rotor 106, and more specifically the section of the rotor overlaid by the mass 112, such that a radial spacing is provided between the mass 112 and the rotor 106.

The rotor 106 has a substantially annular recess 114 formed in its outer radial surface. The balancing mass 112 is configured to be at least partially received in the annular recess 114. Depending upon the relative position of the balancing mass 112 to the rotor 106, the balancing mass 112 may be partially received in the annular recess 114 around the entire circumference of the rotor 106, or partially received in the annular recess 114 about only a portion of the circumference of the rotor 106.

The annular recess 114 has an axial length slightly larger than the axial length of the balancing mass 112, such that the mass 112 is prevented from moving axially relative to the rotor 106 by the recess 114. In this way, the annular recess 114 is configured to secure the balancing mass 112 at a fixed axial position relative to the rotor 106.

The annular recess 114 is formed at the joint 106c between the rotor components 106a,b. The first rotor component 106a comprises recessed portion 116 at its rearward axial end having a reduced outer radius, and the second rotor component 106b comprises an annular groove 118 on its axial end-face into which the axial end of the recessed portion of the first rotor component 106a is received. This construction may enable the balancing mass 112 to be installed onto the rotor 106, by placing the mass 112 on the recessed portion 116 of the first rotor component 106a before it is joined to the second rotor component 106b.

In order to adjust the balancing of the rotor 106 in-situ, the relative position of the balancing mass 112 to the rotor 106 can be altered by a mass adjustment apparatus 120.

The mass adjustment apparatus 120 comprises three moveable spacing elements, in the form of grub screws 122, which are configured to contact the balancing mass 112 and the rotor 106, so as to set the radial spacing between the balancing mass 112 and the rotor 106. The grub screws 122 are received in three corresponding bores 124 formed radially through the balancing mass 112. Each bore 124 has an opening provided on the outer radial surface of the balancing mass 112 to provide access to the grub screw 122. In this example, three grub screws 122 are provided, but it should be understood that other numbers of moveable spacing elements may be able to achieve similar adjustment of an annular balancing mass in accordance with the present disclosure.

In this example, the moveable spacing elements and, more generally, the mass adjustment apparatus are embodied in a simple mechanical system using grub screws, so as to provide a robust and reliable system. However, it will be appreciated that there are other arrangements which may achieve similar adjustment of the balancing mass in-situ, such as electro-mechanical actuators,

The bores 124, and thus the grub screws 122, are spaced equidistantly circumferentially about the balancing mass 112. Each of the grub screws 122 is radially moveable relative to the balancing mass 112 (as shown by the arrow in FIG. 2) by rotating the grub screw 122. Each grub screw 122 can be adjusted independently to protrude from the radially inner surface of the balancing mass 112 by a set distance in order to set the radial spacing between the balancing mass 112 and the rotor 106 at a plurality of discrete positions about a circumference of the rotor 106. In addition, the grub screws 122 can be tightened in order to grip the rotor 106 and thereby secure the balancing mass 112 to the rotor 106.

Each bore 124 comprises a flange 125 which extends into the bore 124 at the radially outer end, such that the radially outer opening of the bore has a diameter less than the diameter of the grub screw 122. This arrangement may prevent potential release of a grub screw 122 out of the bore 124 into the engine gas path, thereby improving safety.

As shown in FIG. 3, the grub screws 122 may be adjusted in order to provide a non-uniform radial separation between the balancing mass 112 and the rotor 106 about the circumference of the rotor 106. In FIG. 3, the difference in diameter between the mass 112 and the rotor 106 is significant to better illustrate the concept, but it should be understood that the difference in diameter may be less or more than that shown.

By providing a non-uniform radial separation between the balancing mass 112 and the rotor 106 about the circumference of the rotor 106, the centre of mass (i.e. the centre axis) of the balancing mass is displaced away from the rotor axis 11. As the balancing mass 112 is secured to the rotor 106, if there is any imbalance in the rotor 106, the grub screws 122 can be adjusted to position the balancing mass 112 such that it offsets the imbalance in the rotor 106.

In order to permit adjustment of the grub screws 122 in-situ, an access port 126 is formed through a wall of the engine casing 23. In this example, the access port 126 may be a pre-existing boroscope port used to inspect the engine 10 without dismantling. The access port 126 is provided at an axial position on the engine casing 23 substantially coincident with the axial position of the balancing mass 112. In this example, three access ports 126 are provided equidistantly around the casing 23, such that the three grub screws 122 may be adjusted concurrently, for example using tools 128. In other examples, a single access port may be provided, in which case the grub screws 122 may be adjusted individually. Plugs may be provided to close the access ports 126 when not in use.

It should be understood that in order to provide balancing function, the balancing mass 112 is configured to rotate with the rotor 106. In particular, the balancing mass 112 is securable in a fixed angular position relative to the rotor 106.

In this example, this angular fixing is provided by three keying features, in the form of keying recesses 130 which are formed in the annular recess 114. Three keying recesses 130 are provided equidistantly about the circumference of the annular recess 114, and each keying recess 130 is shaped to complement the radially inner end of one of the grub screws 122. Therefore, when a grub screw 122 is tightened, it is constrained by the keying recess 130, so as to secure the grub screw 122, and thus the balancing mass 112, in a fixed angular position relative to the rotor 106.

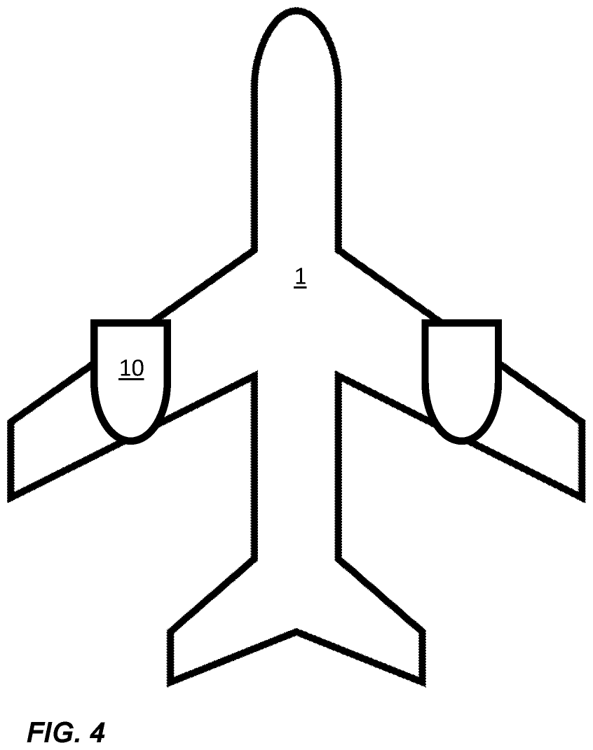

As shown in FIG. 4, a gas turbine engine 10 comprising the gas turbine engine rotor balancing apparatus 100 may be provided on an aircraft 1.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A gas turbine engine rotor balancing apparatus comprising:
a rotor configured to rotate about a rotor axis;
an annular balancing mass configured to encircle the rotor; and
a mass adjustment apparatus for adjusting the position of the balancing mass relative to the rotor.

2. The gas turbine engine rotor balancing apparatus as claimed in claim 1, further comprising an annular engine casing, wherein the rotor, balancing mass, and mass adjustment apparatus are contained within the engine casing.

3. The gas turbine engine rotor balancing apparatus as claimed in claim 2, wherein the engine casing comprises an access port formed through a wall of the engine casing, so as to provide access to the balancing mass and the mass adjustment apparatus within the casing.

4. The gas turbine engine rotor balancing apparatus as claimed in claim 1, wherein the mass adjustment apparatus comprises a moveable spacing element configured to contact the balancing mass and the rotor so as to set a radial spacing between the balancing mass and the rotor.

5. The gas turbine engine rotor balancing apparatus as claimed in claim 4, wherein the mass adjustment apparatus comprises a plurality of movable spacing elements spaced circumferentially so as to set the radial spacing between the balancing mass and the rotor at a plurality of discrete positions about a circumference of the rotor.

6. The gas turbine engine rotor balancing apparatus as claimed in claim 4, wherein the mass adjustment apparatus comprises three moveable spacing elements spaced equidistantly about the circumference of the balancing mass.

7. The gas turbine engine rotor balancing apparatus as claimed in claim 4, wherein the position of the moveable spacing element is moveable relative to the balancing mass.

8. The gas turbine engine rotor balancing apparatus as claimed in claim 4, wherein the moveable spacing element is a grub screw provided on the balancing mass, the grub screw being configured to move radially relative to the balancing mass by rotation of the grub screw.

9. The gas turbine engine rotor balancing apparatus as claimed in claim 4, wherein the moveable spacing element is arranged in a radially extending bore through the balancing mass, and wherein a radially-outer opening of the bore is smaller than the moveable spacing element.

10. The gas turbine engine rotor balancing apparatus as claimed in claim 1, wherein the balancing mass is configured to rotate with the rotor, optionally wherein the mass adjustment apparatus is configured to secure the balancing mass in a fixed position relative to the rotor, such that the balancing mass rotates with the rotor.

11. The gas turbine engine rotor balancing apparatus as claimed in claim 10, wherein at least one of the rotor, the balancing mass, or the mass adjustment apparatus comprise one or more keying features configured to secure the balancing mass in a fixed angular position relative to the rotor.

12. The gas turbine engine rotor balancing apparatus as claimed in claim 1, wherein the rotor comprises an annular recess, and wherein the balancing mass is at least partially received in the annular recess.

13. The gas turbine engine rotor balancing apparatus as claimed in claim 1, wherein the rotor comprises a first rotor component and a second rotor component arranged axially adjacent to the first rotor component, wherein the balancing mass is arranged at, or proximate to, a joint between the first and second rotor components.

14. A gas turbine engine comprising a gas turbine engine rotor balancing apparatus as claimed in claim 1.

15. An aircraft comprising one or more gas turbine engines as claimed in claim 14.
